(19) United States
(12) Patent Application Publication
(10) Pub. No.: US 2023/0074437 A1
(43) Pub. Date: Mar. 9, 2023

(54) ARCUATE PATH ADJUSTMENTS FOR PRINTHEAD ASSEMBLY

(71) Applicant: HEWLETT-PACKARD DEVELOPMENT COMPANY, L.P., Spring, TX (US)

(72) Inventors: Stephen Thomas ROHMAN, Vancouver, WA (US); Saurabh Shripad BHIDE, Vancouver, WA (US); Daniel Ethan Frantz QUARTO, Vancouver, WA (US)

(21) Appl. No.: 17/795,801

(22) PCT Filed: Jan. 30, 2020
(86) PCT No.: PCT/US2020/015878

§ 371 Date: Jul. 27, 2022

(51) Int. Cl. B41J 2/14

(52) U.S. Cl. CPC B41J 2/14; B41J 2002/14362; B41J 2002/14491

(57) ABSTRACT

Example systems are disclosed for printing an image. In one example, the system includes a printhead assembly including a plurality of printheads to deposit printing fluid on a print media as the printhead assembly is moved across the print media along an arcuate path. In addition, the system includes a controller assembly communicatively coupled to the printhead assembly, wherein the controller assembly is to adjust a timing of printing fluid deposition onto the print media from the plurality of printheads based on relative positions and orientations of the printheads along the arcuate path.

### BACKGROUND

A printer may deposit a printing fluid (e.g., a liquid printing agent such as, for instance, ink) onto a print media (e.g., paper) to form an image or multiple images (e.g., words, pictures, graphics, a combination thereof, etc.). During a printing operation, a printhead or other printing fluid deposition device may be traversed across the print media, and the release or deposition of printing fluid may be timed according to the movement so that the image(s) is formed on the print media.

### BRIEF DESCRIPTION OF THE DRAWINGS

Various examples will be described below referring to the following figures:

FIGS. 1 and 2 are sequential top views of a printer performing a printing operation along an arcuate path according to some examples;

FIG. 3 is a bottom, schematic view of the printer of FIGS. 1 and 2 according to some examples;

FIG. 4 is a schematic diagram of the printer of FIGS. 1 and 2 according to some examples;

FIG. 5 is a schematic, enlarged view of the printer of FIGS. 1 and 2 showing the relative spacing and arrangement of various components according to some examples;

FIG. 6 is a diagram depicting a relative orientation change for printheads within a printhead assembly of a printer at a point along an arcuate path according to some examples;

FIG. 7 is a diagram of a method according to some examples;

FIG. 8 is a top view of a printer coupled to a guide for guiding the printer along an arcuate path according to some examples;

FIG. 9 is a cross-sectional view of the guide of FIG. 8 taken along section A-A in FIG. 8; and

FIGS. 10-12 are top views of a printer coupled to guides for guiding the printer along an arcuate path according to some examples.

### DETAILED DESCRIPTION

As previously described above, a printer or printing assembly may traverse a print head (or a plurality of printheads) across a print media (e.g., paper) while simultaneously depositing a printing fluid from the print head (or printheads) so as to form an image (or plurality of images) on the print media. In many printing applications (e.g., such as a color printing), an image may be formed from multiple layers of printing fluid (e.g., such as multiple layers of different colored printing fluid). Thus, during printing operations, a timing of printing fluid deposition on the print media may influence the alignment and ordering of the layers of printing fluid to form the final image(s). In some applications, a user may wish to print an image along an arcuate path; however, an arcuate path introduces a number of complexities and variances to printhead position and orientation, so that printing fluid layers within the image may not be accurately aligned (e.g., so that a so-called “rainbow effect” might result for a multiple layered color image). Accordingly, examples disclosed herein include printhead assemblies (e.g., printers) that are to adjust a printing fluid release timing when the printhead assembly is traversed along an arcuate path, so as to improve printing fluid deposition accuracy and therefore the quality of the final image(s) formed on print media by the printhead assembly.

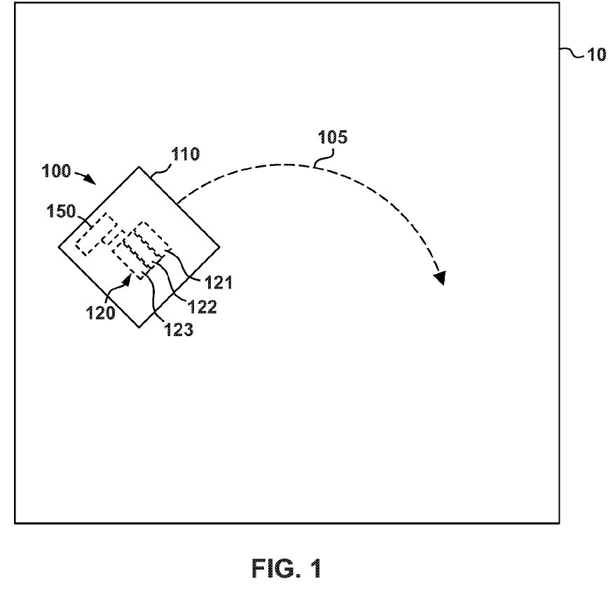

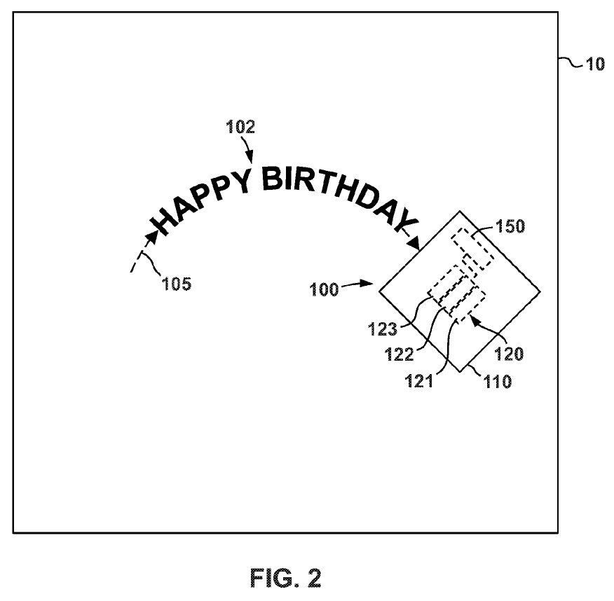

Referring now to FIGS. 1 and 2, a printer 100 is shown traversed across a print media 10 along an arcuate path 105 to form (e.g., print) an image 102 on the print media 10. In this example, the print media 10 comprises a piece of paper; however, in some examples, print media 10 may comprise any suitable surface or object that may receive printing fluid to form an image (e.g., image 102). For instance, in some examples, print media 10 may comprise a piece or surface of cardboard, wall (e.g., such as a wall within a house, office, or other structure), a textile (e.g., cloth), wood, etc.

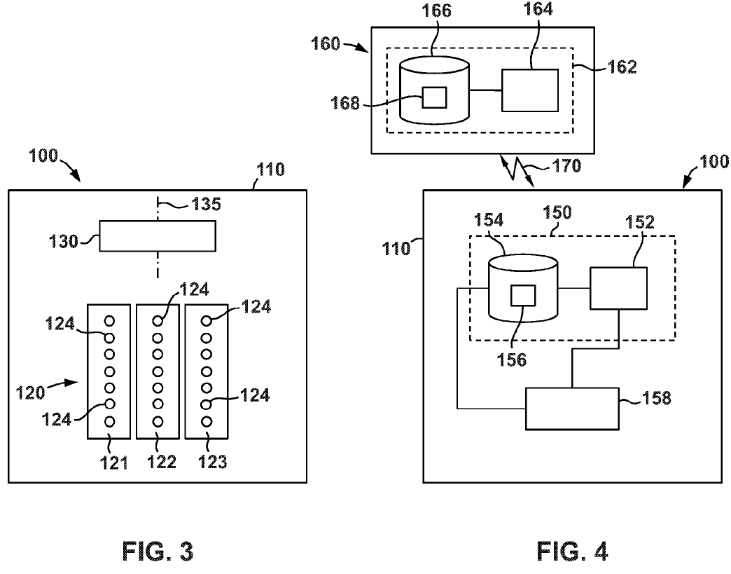

In addition, in this example, printer 100 comprises a so-called “hand-held printer” that is to be grasped by the hand of a user and moved by the user across the print media 10 to form the image 102 thereon. In other examples, printer 100 may comprise a printer that feeds print media therethrough during a printing operation. Generally speaking, printer 100 includes a housing 110, a printhead assembly 120 mounted within (e.g., partially within) the housing 110, and a control assembly 150 disposed within the housing 110. The printhead assembly 120 includes a plurality of printheads 121, 122, 123. In this example, printer 100 is a color printer, so that printhead assembly 120 is to deposit printing fluid (e.g., liquid printing agent) of different colors onto print media 10 to form image 102. More particularly, each printhead 121, 122, 123 may deposit printing fluid of a different color onto print media 10 during operations. In addition, combinations of the different colored printing fluids from printheads 121, 122, 123 (e.g., layered combinations) may result in different colors forming image 102 on print media 10. In some examples, the printhead 121 may emit cyan color printing fluid, the printhead 122 may emit yellow colored printing fluid, and the printhead 123 may emit magenta color printing fluid. However, other color combinations are contemplated for printheads 121, 122, 123 in other examples. Referring briefly FIG. 3, each printhead 121, 122, 123 includes a plurality of nozzles 124. During operations, each printhead 121, 122, 123 may emit printing fluid from the plurality of nozzles 124.

Referring again to FIGS. 1 and 2, during a printing operation, the printer 100 and more specifically the printhead assembly 120 of printer 100 is traversed or moved across print media 10 along arcuate path 105. During this process, printing fluid is deposited from the printheads 121, 122, 123 as previously described above to form the image 102 (which may be a color image). As a result of the movement along arcuate path 105, the timing of printing fluid deposition from the printheads 121, 122, 123 is adjusted so as to ensure that printing fluid from different printheads 121, 122, 123 is accurately layered so as to form the desired image 102 (e.g., including the desired color of image 102). This generally involves accounting for the movement (e.g., speed, acceleration, etc.) of the printer 100 as it is moved along arcuate path 105; however, the curvature of arcuate path 105 also introduces additional complexities. For instance, the orientation of each printhead 121, 122, 123 is changing as printer 100 is moved along arcuate path 105, and the arch length traveled by different portions of printheads 121, 122, 123 is also different than other components of printer 100 (e.g., such as an encoder wheel 130 described below). Thus, during a printing operation, control assembly 150 (and/or another control assembly of another device - such as, e.g., control assembly 162 in FIG. 4) may adjust the timing of printing fluid deposition onto the print media 10 so as to account for the additional complexities and variances that are introduced by the arcuate path 105.

Referring now to FIG. 3, printer 100 includes an encoder wheel 130 adjacent to printhead assembly 120 that is to detect and/or measure a distance traveled by the printer 100 across print media 10 during operations. For instance, encoder wheel 130 may engage with the print media 10 and as printer 100 is traversed along print media 10, the encoder wheel 130 is driven to rotate about an axis 135 (e.g., due to the frictional forces between the encoder wheel 130 and the print media 10). Encoder wheel 130 may have a known diameter, so that a number of revolutions of encoder wheel 130 may be converted (e.g., via control assembly 150 and/or some other control assembly) into a distance traveled by the printer 100.

Referring now to FIG. 4, as previously described above, printer 100 may include a control assembly 150 within housing 110. Control assembly 150 generally includes a processor 152 and a memory 154. The processor 152 (e.g., microprocessor, central processing unit (CPU), or collection of such processor devices, etc.) executes machine-readable instructions 156 (e.g., non-transitory machine-readable medium) provided on memory 154. The memory 154 may comprise volatile storage (e.g., random access memory (RAM)), non-volatile storage (e.g., flash storage, read-only memory (ROM), etc.), or combinations of both volatile and non-volatile storage. Data consumed or produced by the machine-readable instructions 156 can also be stored on memory 154.

In addition, in some examples (e.g., such as the example of FIG. 4), a power source 158 may be disposed within housing 110 of printer 100. Power source 158 may comprise any device or collection of devices that are to receive, store, and deliver electrical power to other components or devices (e.g., processor 152, memory 154, etc.). In some examples, power source 158 comprises a battery or multiple batteries (e.g., a rechargeable battery), but may comprise other suitable power storage device(s) (e.g., capacitors, etc.). In some examples, printer 100 may receive electrical power from a source disposed outside of housing 110 (e.g., such as a wall plug, port on a separate device, etc.) either in addition to or in lieu of power source 158.

Referring now to FIGS. 3 and 4, while not specifically shown, control assembly 150 may be coupled to encoder wheel 130. Thus, during operations, control assembly 150 (and/or another control assembly coupled to control assembly 150) may determine a distance traveled by printer 100 (e.g., along arcuate path 105) so as to time the deposition of printing fluid from the printhead assembly 120.

Referring again to FIG. 4, during operations, printer 100 may be in communication (e.g., constant communication, intermittent communication, etc.) with a separate device 160 or a plurality of separate devices. Device 160 may comprise a device that is to provide, transmit, and/or receive machine-readable instructions (e.g., machine readable instruction 156). For instance, in some examples, device 160 may comprise a computing device (e.g., a laptop computer, desktop computer, tablet computer, smartphone, all-in-one computer, etc.). Thus, during operations, a user (not shown) may initiate a printing operation via the device 160, so that the device 160 may generate machine-readable instructions for printing the image 102 on print media 10. Generally speaking, device 160 includes a processor 164 and a memory 166. As was explained above for processor 152 and memory 154, processor 164 (e.g., microprocessor, central processing unit (CPU), or collection of such processor devices, etc.) executes machine-readable instructions 168 (e.g., non-transitory machine-readable medium) provided on memory 166. The memory 166 may comprise volatile storage (e.g., random access memory (RAM)), non-volatile storage (e.g., flash storage, read-only memory (ROM), etc.), or combinations of both volatile and non-volatile storage. Data consumed or produced by the machine-readable instructions 168 can also be stored on memory 166. It should be noted that processors 152, 164 may execute machine-readable instructions 168 stored on memory 166 and/or machine-readable instructions 156 stored on memory 154.

Device 160 may communicate with printer 100 via a communication link 170 that may comprise any suitable wireless signal (e.g., radio frequency signal, WIFI signal, BLUETOOTH® signal, infrared signal, etc.), wired signal (e.g., electrical cable, fiber optic cable, etc.) or combination thereof. Thus, during operations, control assembly 162 of device 160 may provide instructions to control assembly 150 within printer 100 via the communication link 170 for performing a printing operation, and control assembly 150 may carry out these instructions as the user (not shown) moves the printer 100 along the print media 10 so as to form the image 102 as previously described above. During these operations, and as will be described in more detail below, control assembly 162 and/or control assembly 150 may determine and implement adjustments to the print fluid deposition timing from printheads 121, 122, 123 within printhead assembly 120 based on the curvature of arcuate path 105, according to the examples disclosed herein, so as to ensure a more accurate print deposition and higher quality image 102. As used herein, a “control assembly” may be generally used to refer to a control assembly within a device (e.g., such as control assembly 150 within printer 100, control assembly 162 within device 160) or may be used to refer to a collection of control assemblies within the same or different devices (e.g., such as control assembly 150 within printer 100 and control assembly 162 within device 160).

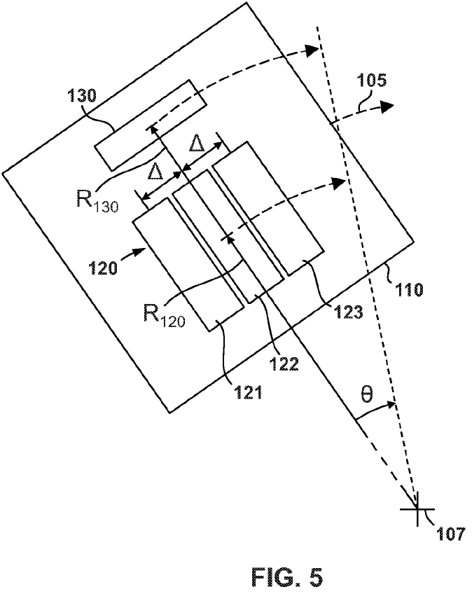

As previously described above, during operations, as printer 100 is traversed along arcuate path 105, the travel distances and orientations of printheads 121, 122, 123 within printhead assembly 120 may be altered from a straight printing path. For instance, reference is now made to FIG. 5, which shows printer 100 moving along arcuate path 105.

As previously described above, the number of revolutions of encoder wheel 130 may be used (e.g., by control assembly 150) to determine a distance traveled by printer 100 across the print media (e.g., print media 10 in FIGS. 1 and 2). As shown in FIG. 5, the printheads 121, 122, 123 may be spaced by a known distance Δ, such that printheads 121, 122 are spaced by distance Δ, printheads 122, 123 are spaced by distance Δ, and printheads 121, 123 are spaced by distance 2Δ. Accordingly, if printer 100 was traversed along a straight line or path, the encoder wheel 130 may traverse the same distance as the printheads 121, 122, 123, so that the offset along the theoretical path of movement (which again is straight and not curved) for the printhead 122 relative to printhead 121 is Δ, and the offset for printhead 123 relative to printhead 121 is 2Δ. During a printing operation, a control assembly (e.g., control assembly 150 and/or control assembly 162 in FIG. 4) may account for the offsets between the printheads 121, 122, 123 along the path of travel when determining a timing of printing fluid deposition therefrom, based on the measured distance traveled by the printer as measured by the encoder wheel 130.

However, when printer 100 is moved along a curved or arcuate path 105, the distance traveled by the encoder wheel 130 and the printheads 121, 122, 123 is not the same. Specifically, the encoder wheel 130 is disposed at a different radius from a center or curvature 107 for arcuate path 105 so that the printheads 121, 122, 123 generally traverse along a different movement arc length than the encoder wheel 130 for a given movement of printer 100. In this example, encoder 130 is disposed at a radius R₁₃₀ from center of curvature 107, and printheads 121, 122, 123 are generally disposed at a radius R₁₂₀ from center of curvature 107 that is less than radius R₁₃₀. In the example of FIG. 5, the radius R₁₂₀ may extend from the center of curvature 107 to a mid-point of the printheads 121, 122, 123, and thus the radius R₁₂₀ may be referred to as an average radius for the printheads 121, 122, 123 along the arcuate path 105. Likewise, in the example of FIG. 5, the radius R₁₃₀ may extend from the center of curvature 107 to a mid-point of the encoder wheel 130, and thus the radius R₁₃₀ may be referred to as an average radius for the encoder wheel 130 along the arcuate path 105.

The movement arc lengths traveled by the encoder wheel 130 and printheads 121, 122, 123 for a given angle of travel θ (in radians) for printer 100 about center of curvature 107 along arcuate path 105 may be provided by the following expressions, respectively:

$${R}_{130} \times θ$$

$${R}_{120} \times θ$$

Because the radius R₁₃₀ is greater than the radius R₁₂₀, these expressions may provide an arc length traveled by the encoder wheel 130 that is greater than an arc length traveled by the printheads 121, 122, 123 for the given movement of printer 100 along arcuate path 105. As a result, when printer 100 is moved along arcuate path 105 the offsets applied to the distance measured by the encoder wheel 130 so as to account for the spacing of the printheads 121, 122, 123 (e.g., Δ, 2Δ, etc.) may be adjusted to account for these differences in arc length between the encoder wheel 130 and printheads 121, 122, 123.

Specifically, in some examples, the arc length traveled by the printheads 121, 122, 123 may be related to the arc length traveled by the encoder wheel 130 by the ratio of R₁₃₀/R₁₂₀. Thus, in some examples, an offset distance for each printhead 121, 122, 123 along arcuate path 105 may be adjusted or converted by this ratio so as to provide an approximation of the offset distance between each printhead 121, 122, 123 during a printing operation along arcuate path 105. In other words, as the printer 100 is traversed along arcuate path 105, the offset between the printheads, 121, 122 along arcuate path 105 may be re-written as Δ(R₁₃₀/R₁₂₀) and the offset between printheads 121, 123 along arcuate path 105 may be re-written as 2Δ(R₁₃₀/R₁₂₀). In some examples, the above expressions may be rewritten in terms of other factors or reference numbers, such as, for instance, a distance or spacing between the encoder wheel 130 and printheads 121, 122, 123. As a result, the offsets between the printheads 121, 122, 123 along the arcuate path 105 may be accurately determined as a function of the radius of curvature for arcuate path 105 (or a radius from some fixed point on printer 100 to the center of curvature 107), and the deposition timing of printheads 121, 122, 123 may be adjusted based on the spacing at the adjusted travel distance so as to improve printing fluid deposition during operations.

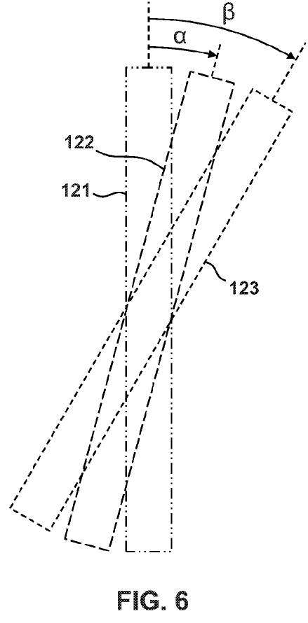

Referring now to FIGS. 5 and 6, during operations, as printer 100 is traversed along arcuate path 105, the orientations of each printhead 121, 122, 123 for a given location on print media 10 along arcuate path 105 may be different. In particular, as shown in FIG. 6, for a given location on print media 10 along arcuate path 105, a first printhead 121, which may be the leading printhead along the arcuate path 105, may have a first orientation. However, as the subsequent printheads 122, 123 are passed over the location on print media 10, they are progressively rotated at greater relative amounts relative to the orientation that the first printhead 121 was in when it passed over the location. Specifically, the printhead 122 may be shifted or rotated from the orientation of printhead 121 by a first angle α, and the printhead 123 may be shifted or rotated from the orientation of printhead 121 by a second angle β that is greater than the angle α. The amount of relative rotation between the printheads 121, 122, 123 along arcuate path 105 (i.e., the values of the angles α, β) may be a function of the spacing between the printheads 121, 122, 123 and the radius R₁₂₀ of the printheads 121, 122, 123 along the arcuate path 105. More specifically, in the example of FIG. 5, wherein the spacing between the printheads 121, 122 is equal to Δ, and spacing between the printheads 121, 123 is equal to 2Δ, the following expressions may be utilized to provide the relative rotations α and β in degrees, shown in FIG. 6 for a given radius R₁₂₀ of the printheads 121, 122, 123:

$$α \left(i n deg r e e s\right) = \frac{\left(360 \times Δ\right)}{\left(2 π \times {R}_{120}\right)}$$

$$β \left(i n deg r e e s\right) = \frac{\left(360 \times 2 Δ\right)}{\left(2 π \times {R}_{120}\right)}$$

Referring now to FIGS. 3 and 6, once the angles α and β are determined, these values may then be used to further adjust the deposition timing of printing fluid from the printheads 121, 122, 123 so as to improve printing fluid deposition during operations. For instance, in some examples, the angles α and β may be utilized to adjust relative deposition timing from individual nozzles 124 of printheads 121, 122, 123. Specifically, nozzles 124 that are disposed toward the upper or lower ends of the printheads 122, 123 may have a more significant timing adjustment due to a greater rotational offset to the relative position of the first printhead 121 as shown in FIG. 6.

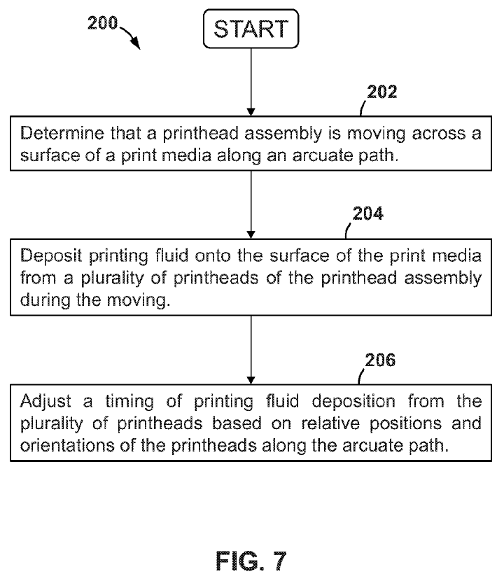

Referring now to FIG. 7, a method 200 is shown. In some examples, method 200 may be a method for printing an image along an arcuate path (e.g., arcuate path 105) with a printer or a printhead assembly of a printer (e.g., printer 100, printhead assembly 120). In explaining the features of method 200, reference will be made to printer 100 described above and shown in FIGS. 1-6; however, method 200 may be practiced in other examples with other devices and assemblies that are different from printer 100.

Initially, method 200 includes determining that a printhead assembly is moving across a surface of a print media along an arcuate path at block 202. The printhead assembly may be the printhead assembly 120 that includes a plurality of printheads 121, 122, 123 (see e.g., FIG. 3). In some examples, the determination at block 202 may be made as a result of a user selection (e.g., a menu selection), a curved print job on a device that is coupled to the printhead assembly, such as, for instance, device 160 and/or printer 100 shown in FIG. 4. In some examples, a device coupled to the printhead assembly (e.g., device 160, printer 100 in FIG. 4) may automatically determine (e.g., sense) that the printhead assembly is moving across a surface of print media along an arcuate path.

In addition, method 200 includes depositing printing fluid onto the surface of the print media from a plurality of printheads of the printhead assembly at block 204 during the moving at block 202. For instance, as previously described, the printhead assembly may comprise the printhead assembly 120 of printer 100 shown in FIG. 3, and the printhead assembly 120 includes a plurality of printheads 121, 122, 123 that are to deposit printing fluid (e.g., liquid printing agent, such as, for instance, ink) onto a surface of print media.

Further, method 200 includes adjusting a timing of printing fluid deposition from the plurality of printheads based on relative positions and orientations of the printheads along the arcuate path at block 206. For instance, adjustments may be made to the timing of printing fluid deposition from the plurality of printheads (e.g., printheads 121, 122, 123 in FIG. 3) based on a difference in arc length traveled for an encoder wheel (e.g., encoder wheel 130 in FIG. 3) that is to measure or detect distance traveled by the printhead assembly 120 and the printheads along the arcuate path (e.g., arcuate path 105). In addition or in the alternative, adjustments may be made to the timing of printing fluid deposition from the plurality of printheads (e.g., printheads 121, 122, 123 in FIG. 3) based on a difference in orientation of each printhead 121, 122, 123 at a specific deposition location along the print media (e.g., print media 10). Both of these adjustments may be made according to the examples previously described above for printer 100.

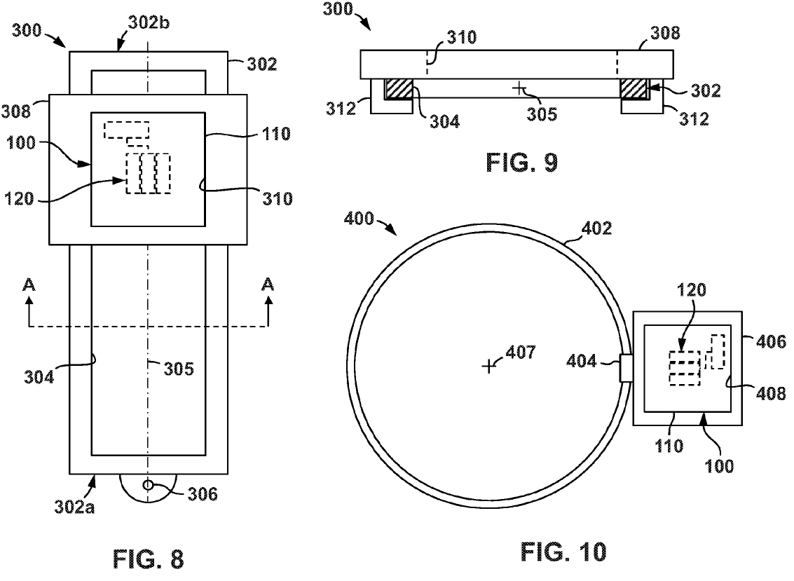

In some examples, printer 100 may be coupled to a guide so as to facilitate accurate movement of the printer 100 along the arcuate path 105 (see e.g., FIGS. 1 and 2). For instance, reference is now made to FIGS. 8-11, which show various examples of different guides that may be used with the printer 100 during operations. However, the specifically depicted example guides should not be interpreted as limiting the various other designs and types of guides that may be used with the printer 100 during printing operations. In addition, as is generally shown in FIGS. 1 and 2, in some examples, printer 100 may be operated to print an image (e.g., image 102) without the use of a guide, such as those shown in FIGS. 8-11 and discussed in more detail below.

Referring now to FIGS. 8 and 9, in some examples, printer 100 may be coupled to a guide 300 to guide the printer 100 along an arcuate path (e.g., arcuate path 105 shown in FIGS. 1 and 2) during printing operations. Guide 300 includes a frame 302 including a central or longitudinal axis 305, a first or inner end 302a, and a second or outer end 302b axially opposite inner end 302a with respect to axis 305. An elongate aperture or slot 304 extends axially along the frame 302 and is axially positioned between the ends 302a, 302b with respect to axis 305.

A sled 308 is coupled to the frame 302 such that sled 308 may slide axially along the slot 304. Sled 308 includes an aperture or slot 310 that is to receive the housing 110 of printer 100 therein during operations. In some examples, the sizing of the slot 310 may be chosen so as to form an interference fit with the housing 110, or may exhibit a sufficient amount of frictional engagement with the housing 110 so that accidental removal of housing 110 from slot 310 is restricted. In addition, as is best shown in FIG. 9, in some examples, sled 308 may include a pair of rails 312 that engage with the frame 302 so as to couple the sled 308 to frame 302 and allow sled 308 to axially traverse along frame 302 relative to axis 305.

An alignment aperture 306 is disposed at inner end 302a. The alignment aperture 306 is to establish a pivot point for the frame 302 during printing operations. Specifically, the alignment aperture 306 may be aligned with the center of curvature for the arcuate printing path (e.g., arcuate path 105 in FIGS. 1 and 2) during operations. In some examples, a pencil or other object may be inserted through the alignment aperture 306 so as to fix the frame 302 on a piece of print media (e.g., print media 10) with respect to the center of curvature for the desired arcuate path (e.g., arcuate path 105).

During operations, a user may place and secure the frame 302 on a piece of print media (e.g., print media 10 in FIGS. 1 and 2) so that the alignment aperture 306 is aligned with the center of curvature for the desired arcuate printing path (e.g., arcuate path 105 in FIGS. 1 and 2). In addition, the printer 100 may be placed within the aperture 310 of sled 308 and the sled 308 may be slid along slot 304 of frame 302 so that the printer 100 is placed at the desired or requested radius from the center of curvature (i.e., from the alignment aperture 306). Thereafter, printing operations may be initiated whereby printing fluid (e.g., ink) is deposited from the printhead assembly 120 of printer 100 while the printer 100 is moved along an arcuate path as previously described above. However, during these operations with guide 300, the printer 100 is guided along the desired arcuate path by pivoting the frame 302 about the center of curvature at alignment aperture 306.

Referring now to FIG. 10, in some examples, printer 100 may be coupled to a guide 400 to guide the printer 100 along an arcuate path (e.g., arcuate path 105 shown in FIGS. 1 and 2) during printing operations. Guide 400 includes a ring-shaped frame 402 and a sled 406 movably coupled to the frame 402. In particular, sled 406 is coupled to the ring-shaped frame 402 via a collar 404 that is to slidingly engage the frame 402. Thus, during operations, sled 406 may be slidingly traversed around an entire circumference of frame 402 via the collar 404. A center point of the ring-shaped frame 402 may define a center of curvature 407 for the frame 402, which corresponds to a center of curvature for the arcuate printing path defined by frame 402.

Sled 406 includes an aperture or slot 408 that is to receive the housing 110 of printer 100 therein during operations. In some examples, the sizing of the slot 408 may be chosen so as to form an interference fit with the housing 110, or may exhibit a sufficient amount of frictional engagement with the housing 110 so that accidental removal of housing 110 from slot 408 is restricted.

During operations, a user may place and secure the frame 402 on a piece of print media (e.g., print media 10 in FIGS. 1 and 2) so that the center 407 of frame 402 is aligned with the center of curvature for the desired arcuate printing path (e.g., arcuate path 105 in FIGS. 1 and 2). In addition, the printer 100 may be placed within the aperture 408 of sled 406 and the sled 406 may be moved along the ring-shaped frame 402 via sliding engagement between the collar 404 and frame 402, so that the printer 100 is traversed along the desired or requested arcuate path as previously described. During this movement of printer 100, printing operations may be initiated whereby printing fluid (e.g., ink) is deposited from the printhead assembly 120 of printer 100 while the printer 100 is moved along the arcuate path as previously described above. However, during these operations with guide 400, the printer 100 is guided along the desired arcuate path by pivoting the frame 402 and sled 406 about the center of curvature at center 407 of frame 402.

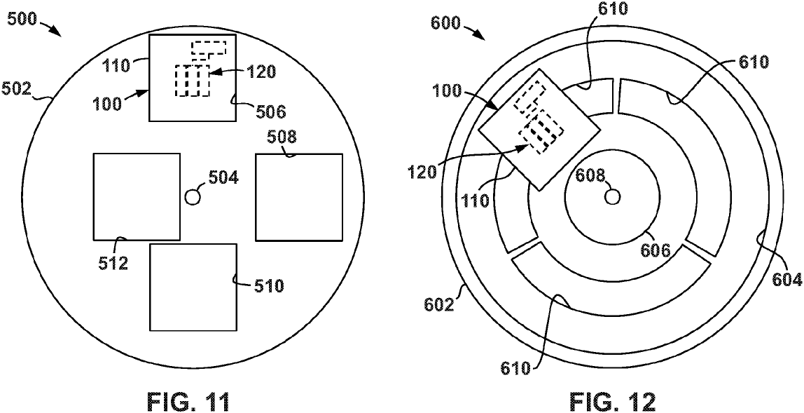

Referring now to FIG. 11, in some examples, printer 100 may be coupled to a guide 500 to guide the printer 100 along an arcuate path (e.g., arcuate path 105 shown in FIGS. 1 and 2) during printing operations. Guide 500 includes a round plate frame 502 that includes a central alignment aperture 504 and a plurality of mounting apertures 506, 508, 510, 512 disposed about alignment aperture 504 and positioned at different distances from alignment aperture 504.

Alignment aperture 504 is disposed at a central point within frame 502 and is to establish a pivot point for the frame 502 during printing operations. Specifically, the alignment aperture 504 may be aligned with the center of curvature for the arcuate printing path (e.g., arcuate path 105 in FIGS. 1 and 2) during operations. In some examples, a pencil or other object may be inserted through the aperture 504 so as to fix the frame 502 on a piece of print media (e.g., print media 10) with respect to the center of curvature for the desired arcuate path (e.g., arcuate path 105).

Each mounting aperture 506, 508, 510, 512 is to receive the housing 110 of printer 100 therein during operations. In some examples, the sizing of the mounting apertures 506, 508, 510, 512 may be chosen so as to form an interference fit with the housing 110, or may exhibit a sufficient amount of frictional engagement with the housing 110 so that accidental removal of housing 110 therefrom is restricted. The positioning of each mounting aperture 506, 508, 510, 512 relative to the alignment aperture 504 along frame 502 is such that during operations, each mounting aperture 506, 508, 510, 512 may trace a different arc about a center of curvature aligned with alignment aperture 504 as frame 502 is rotated about the center of curvature. Thus, as will be explained in more detail below, placement of the printer 100 within a select one of the mounting apertures 506, 508, 510, 512 is to facilitate printing along different arcuate paths (see e.g., arcuate path 105) along the print media.

During operations, a user may place and secure the frame 502 on a piece of print media (e.g., print media 10 in FIGS. 1 and 2) so that the alignment aperture 504 is aligned with the center of curvature for the desired arcuate printing path (e.g., arcuate path 105 in FIGS. 1 and 2). In addition, the printer 100 may be placed within a select one of the mounting apertures 506, 508, 510, 512 within frame 502 and the entire frame 502 may be rotated about the alignment aperture 504 so that the printer 100 is traversed along the desired arcuate path. During the movement of the printer 100, printing fluid (e.g., ink) is deposited from the printhead assembly 120 of printer 100 as previously described above. However, during these operations with guide 500, the printer 100 is guided along the desired arcuate path by pivoting the frame 502 about the center of curvature at alignment aperture 504.

Referring now to FIG. 12, in some examples, printer 100 may be coupled to a guide 600 to guide the printer 100 along an arcuate path (e.g., arcuate path 105 shown in FIGS. 1 and 2) during printing operations. Guide 600 includes a round plate frame 602 that includes a central alignment aperture 608. In addition, frame 602 includes a first or inner annular alignment wall 606, and a second or outer annular alignment wall 604 both extending about the central alignment aperture 608. A plurality of annular slots 610 are disposed about alignment aperture 608, and positioned between the annular alignment walls 604, 606. In this example, there are a total of three annular slots 610 disposed about alignment aperture 608; however, there may be greater or fewer than three annular slots 610 in other examples.

Alignment aperture 608 is disposed at a central point within frame 602 and is to establish a center of curvature for an arcuate printing path (see e.g., arcuate path 105 in FIGS. 1 and 2) during printing operations. In some examples, a pencil or other object may be inserted through the alignment aperture 608 so as to fix the frame 602 on a piece of print media (e.g., print media 10) with respect to the center of curvature for the desired arcuate path (e.g., arcuate path 105).

Printer 100 may be disposed between the inner and outer annular walls 606 and 604, respectively. Thus, the spacing between the inner and outer annular walls 606 and 604, respectively, may be sized so as to receive the housing 110 of printer 100 therein during operations. In addition, the sizing and shape of the inner and outer annular walls 606 and 604, respectively, may be such that the printer 100 may be annularly traversed between the walls 606, 604 along an arcuate path having a center of curvature aligned with the alignment aperture 608. In addition, the annular slots 610 may be positioned between the walls 606, 604 and appropriately sized and shaped so as to allow the passage of printing fluid (e.g., ink) from the printhead assembly 120 therethrough during operations.

During operations, a user may place and secure the frame 602 on a piece of print media (e.g., print media 10 in FIGS. 1 and 2) so that the alignment aperture 608 is aligned with the center of curvature for the desired arcuate printing path (e.g., arcuate path 105 in FIGS. 1 and 2). In addition, the printer 100 may be placed on frame 602, between the inner and outer annular walls 606 and 604, respectively, so that printhead assembly 120 is generally aligned with a select one of the annular slots 610. Thereafter, the printer 100 may be annularly traversed along the frame 602 between the annular walls 604, 606 so that printer 100 is traversed along the desired arcuate path. During the movement of the printer 100, printing fluid (e.g., ink) is deposited from the printhead assembly 120 of printer 100 as previously described above, and the deposited printing fluid is emitted through the annular slot(s) 610 so as to be deposited on the print media.

As described above, examples disclosed herein include printhead assemblies (e.g., printers) that are to adjust a printing fluid release timing when the printhead assembly is traversed along an arcuate path, so as to improve printing fluid deposition accuracy and therefore the quality of the final image(s) formed on print media by the printhead assembly. As a result, through use of the examples disclosed herein, printing operations along an arcuate printing path may be improved.

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the preceding discussion and in the claims, the terms “including” and “comprising” are used in an open-ended fashion, and thus should be interpreted to mean “including, but not limited to....” Also, the term “couple” or “couples” is intended to be broad enough to encompass both indirect and direct connections. Thus, if a first device couples to a second device, that connection may be through a direct connection or through an indirect connection via other devices, components, and connections. In addition, as used herein, the terms “axial” and “axially” generally refer to positions along or parallel to a central or longitudinal axis (e.g., central axis of a body or a port), while the terms “radial” and “radially” generally refer to positions located or spaced to the side of the central or longitudinal axis.

As used herein, including in the claims, the word “or” is used in an inclusive manner. For example, “A or B” means any of the following: “A” alone, “B” alone, or both “A” and “B.” In addition, when used herein including the claims, the word “generally” or “substantially” means within a range of plus or minus 10% of the stated value.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A system, comprising:
a printhead assembly comprising a plurality of printheads to deposit printing fluid on a print media as the printhead assembly is moved across the print media along an arcuate path; and
a controller assembly communicatively coupled to the printhead assembly, wherein the controller assembly is to adjust a timing of printing fluid deposition onto the print media from the plurality of printheads based on relative positions and orientations of the printheads along the arcuate path.

2. The system of claim 1, wherein the printhead assembly comprises an encoder wheel to measure a distance traveled by the printhead assembly as the printhead assembly is moved along the arcuate path, wherein the controller assembly is to adjust the timing of printing fluid deposition based on a difference between a movement arc length of the encoder wheel and the printheads along the arcuate path.

3. The system of claim 2, wherein the controller is to adjust the timing of printing fluid deposition from the plurality of printheads based on a ratio of an encoder wheel radius to an average print head radius relative to a center of rotation for the arcuate path.

4. The system of claim 1, wherein the controller is to determine a relative rotation angle offset of the plurality of printheads along the arcuate path, and is to adjust the timing of printing fluid deposition from the plurality of printheads based on the relative rotation angle offset.

5. The system of claim 4, wherein adjusting the timing of printing fluid deposition based on the relative angle offset comprises adjusting a relative timing of printing fluid deposition from a plurality of nozzles within each print head.

6. The system of claim 1, comprising a guide that is to be coupled to the printhead assembly, and that is to guide the printhead assembly along the arcuate path.

7. A system, comprising:
a printer comprising a plurality of printheads to deposit printing fluid on a print media;
a guide to be coupled to the printer, wherein the guide is to guide the printer across the print media along an arcuate path; and
a controller assembly communicatively coupled to the plurality of printheads, wherein the controller assembly is to adjust a timing of printing fluid deposition on the print media from the plurality of printheads based on a radius of curvature of the arcuate path.

8. The system of claim 7, wherein the guide frame is to adjust the radius of curvature of the arcuate path.

9. The system of claim 8, wherein the controller assembly is to determine a relative rotation angle offset of the plurality of printheads along the arcuate path, and is to adjust the timing of printing fluid deposition based on the relative rotation angle offset.

10. The system of claim 9, wherein the printer comprises an encoder wheel to measure a distance traveled by the printer as the printer is moved along the arcuate path, wherein the controller assembly is to adjust the timing of printing fluid deposition based on a difference in arc length between the encoder wheel and the plurality of printheads as the printer is moved along the arcuate path.

11. The system of claim 10, wherein the controller assembly is to adjust the timing of printing fluid deposition based on a ratio of an encoder wheel radius to a radius of the plurality of printheads radius relative to a center of rotation for the arcuate path.

12. A method, comprising:
determining that a printhead assembly is moving across a surface of a print media along an arcuate path;
depositing printing fluid onto the surface of the print media from a plurality of printheads of the printhead assembly during the moving; and
adjusting a timing of printing fluid deposition from the plurality of printheads based on relative positions and orientations of the printheads along the arcuate path.

13. The method of claim 12, wherein adjusting the timing of printing fluid deposition comprises:
determining a relative rotation angle offset of the plurality of printheads along the arcuate path; and
adjusting the timing of printing fluid deposition based on the relative rotation angle offset.

14. The method of claim 12, comprising:
measuring a distance traveled during the moving with an encoder wheel coupled to the printhead assembly during the moving; and
adjusting the timing of printing fluid deposition based on a difference between a movement arc length of the encoder wheel and the printheads along the arcuate path.

15. The method of claim 14, comprising:
coupling the printhead assembly to a guide; and
guiding the printhead assembly along the arcuate path with the guide during the moving.
